(19) United States
(12) Patent Application Publication
(10) Pub. No.: US 2025/0027210 A1
(43) Pub. Date: Jan. 23, 2025

(54) ANODE PACK ASSEMBLY WITH MICRO-EXPANDED METAL MESH POROUS TRANSPORT LAYER (PTL) FOR USE IN PROTON EXCHANGE MEMBRANE (PEM) ELECTROLYZERS AND METHODS OF MANUFACTURING THE SAME

(71) Applicant: ACS Industries, Inc., Lincoln, RI (US)

(72) Inventors: Timothy Davenport, Cumberland, RI (US); George Greenwood, Tiverton, RI (US)

(73) Assignee: ACS Industries, Inc., Lincoln, RI (US)

(21) Appl. No.: 18/776,158

(22) Filed: Jul. 17, 2024

Related U.S. Application Data
(60) Provisional application No. 63/514,262, filed on Jul. 18, 2023.

(51) Int. Cl. C25B 9/23; C25B 11/032; C25B 11/036; C25B 11/042

(52) U.S. Cl. CPC C25B 9/23; C25B 11/032; C25B 11/036; C25B 11/042

(57) ABSTRACT

A PEM electrolyzer PTL is created from micro-expanded mesh metal foil layers to allow for a precise level of control over the thickness of the layers, porosity, tortuosity, pore size, interlayer connectivity, and surface roughness. Pore sizes range from 3 μm to 30 μm with a porosity (mesh open area) of 10-50%. A PEM anode pack assembly is formed from the micro-expanded PTL layers with a multi-layer expanded metal flow field and bipolar plate. The 3 subcomponents are diffusion bonded together to form an integrated pack and PVD coated on the outside surfaces.

### CROSS-REFERENCE TO RELATED APPLICATIONS

This application claims the benefit of U.S. Provisional Patent Application No. 63/514,262, filed Jul. 18, 2023, the entire contents of which is incorporated herein by reference.

### BACKGROUND OF THE DISCLOSURE

The present disclosure relates generally to Proton Exchange Membrane (PEM) hydrogen electrolyzer devices, and more particularly to a novel anode pack assembly which includes a Porous Transport Layer (PTL) formed from stack of multiple diffusion bonded layers of micro-expanded metal mesh.

A PEM electrolyzer is composed of a stack, or stacks, of cells each composed of an anode bipolar plate, an anode side flow field, an anode PTL, an anode catalyst layer, a central proton conducting membrane, a cathode catalyst layer, a cathode PTL, a cathode side flow field and a cathode bipolar plate. The stack(s) are secured within an electrolyzer frame with water inputs and gas outputs. (See FIG. 1).

Operation of hydrogen electrolyzers is well known in the art wherein water is circulated through the stack on each side of the PEM, and electrical energy is applied on each side of the anode and cathode. The water supply on each side flows through the flow fields and PTL's to reach the inner catalyst layers where the chemical reaction occurs across the PEM. The resulting chemical reaction across the PEM splits water molecules and produces hydrogen on the cathode side and oxygen on the anode side.

Catalyst materials are well known in the art and are typically applied to the PEM which is immediately adjacent to the respective PTL layers. Performance of the electrolyzer is highly dependent on catalyst materials and density, electrical contact of the various layers (ohmic resistance), pore sizes of the flow fields and PTLs, flow paths and flow rates through the various layers. Optimal pore diameters of the PTL have been reported in the range from 6 μm to 15 μm with porosity in excess of 20%. However, creating materials with these properties is both difficult and expensive.

In the prior art, to achieve very small pore sizes of the PTL, the anode PTL is typically made of sintered Titanium (Ti) powder, sintered Ti fibers, porous Ti foils, or metal mesh Ti. Pore sizes for conventional metal mesh are typically between 100 μm and 1 mm. Pore sizes for metal foil (mask-patterned wet-etching lithography) are limited to about 100 μm which make them more suitable for larger diameter flow fields rather than the PTL layers. Pore sizes for sintered Titanium powder materials can be achieved in the 6 μm to 20 μm range. However, sintered Ti powder PTLs are expensive to produce and have more random interstitial spaces which limit flow and reactivity at certain locations in the PTL. Additionally, there is a limit to the porosity of the materials based on the powder particle diameter size.

Accordingly, there is a need in the industry for less expensive and more uniform materials to form the PTL layer(s) of the electrolyser stack.

### SUMMARY OF THE DISCLOSURE

Ideally, the PTL should be a composite of several layers of Titanium material (foils or sheets) with each layer having uniform pore size and distribution, and each layer having a successively smaller pore size to create free and direct flow patterns from the flow field to the catalyst layer.

A PTL in accordance with the teachings of the present invention is created from micro-expanded Ti metal mesh layers to allow for a precise level of control over the thickness of the individual layers, porosity, tortuosity, pore size, interlayer connectivity, and surface roughness while resulting in a near zero distribution in pore sizes.

In particular, the invention pertains to the application and manufacture of an anode side sub-assembly formed from a plurality of micro-expanded metal mesh layers, and further an anode pack assembly comprising the novel micro-expanded PTL together with an bonded flow field and bipolar.

This invention directly relates to the use of a “micro-expanded” metal mesh PTL sub-assembly (micro-expanded metal foil layers) with the novel properties of pore sizes of 3-30 μm pores and a porosity (mesh open area) of 10-50% and further relates to methods for manufacturing the expanded metal mesh and the anode pack assembly.

The flow field layers may comprise expanded metal foil or sheet layers which have larger pore sizes of 100 μm or greater and which are manufactured using more conventional metal expanding, wet-etch lithography, laser or other suitable technologies.

In some embodiments, the bipolar plate, flow field layers and porous transport layers are stacked and vacuum diffusion bonded into a single integrated pack assembly thus eliminating the need to coat each individual layer and improving the contact interface between each layer.

The outer side edges of the bonded stack are trimmed to a desired size for assembly with the other components of the PEM stack. The anode pack is also coated with platinum group conducting metals on the PTL side using Physical Vapor Deposition (PVD) coating methods in a high throughput coating line and gold materials on the bipolar plate side, coating only the outside surfaces, thereby reducing coating material cost and increasing production speed and efficiency.

Objectives of the present anode pack design and manufacturing processes are improved electrolyzer performance through better electrical contact between the various layers, more uniform flow paths through the flow field and PTL, and reduced manufacturing costs by assembling the bipolar plate, flow field and PTL as a single integrated component.

While embodiments of the invention have been described as having the features recited, it is understood that various combinations of such features are also encompassed by particular embodiments of the invention and that the scope of the invention is limited by the claims and not the description.

### BRIEF DESCRIPTION OF THE DRAWING FIGURES

While the specification concludes with claims particularly pointing out and distinctly claiming particular embodiments of the instant invention, various embodiments of the invention can be more readily understood and appreciated from the following descriptions of various embodiments of the invention when read in conjunction with the accompanying drawings in which:

FIG. 1 is a schematic layer view of an exemplary PEM electrolyzer cell stack;

FIG. 2 is an illustration of an exemplary anode pack assembly including an anode bipolar plate, a multi-layer porous flow field and a multi-layer anode porous transport layer constructed from a plurality of micro-expanded metal mesh layers in accordance with the teachings of the present invention;

FIG. 3 is an illustration of an exemplary micro-expanded mesh PTL design formed from three separate micro-expanded Ti foil sheets (separated on the left and combined on the right);

FIG. 4 is an illustration of an exemplary metal mesh expanding process;

FIG. 5 is an illustration of a proposed micro-expanding apparatus in accordance with the teachings of the present invention;

FIG. 6 is an illustration of an exemplary PVD apparatus in accordance with the teachings of the present invention; and

FIG. 7 is a flow chart illustration a method for manufacturing a completed anode pack in accordance with the teachings of the present invention.

### DETAILED DESCRIPTION OF THE EXEMPLARY EMBODIMENTS

Certain exemplary embodiments will now be described to provide an overall understanding of the principles of the structure, function, manufacture, and use of the device and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present disclosure. Further, in the present disclosure, like-numbered components of the embodiments generally have similar features, and thus within a particular embodiment each feature of each like-numbered component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape. Further, to the extent that directional terms like top, bottom, up, or down are used, they are not intended to limit the systems, devices, and methods disclosed herein. A person skilled in the art, will recognize that these terms are merely relative to the system and device being discussed and are not universal.

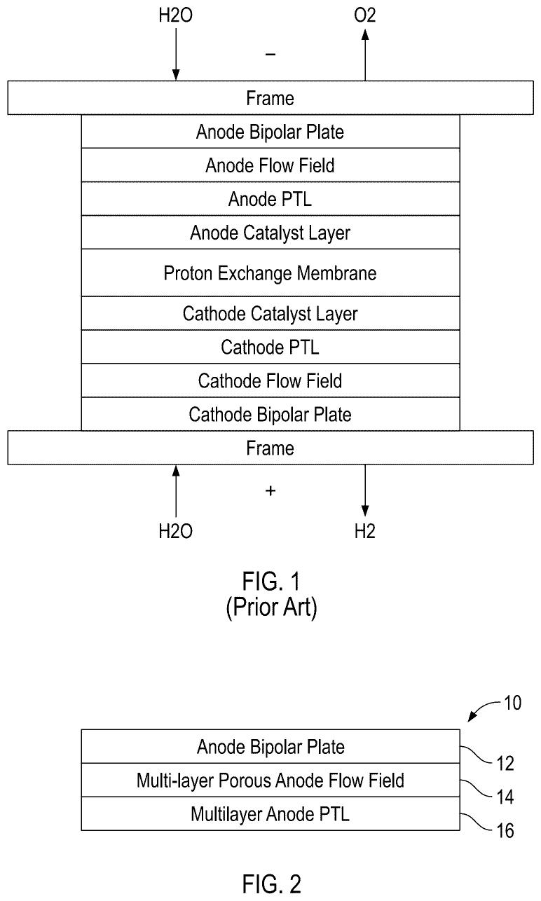

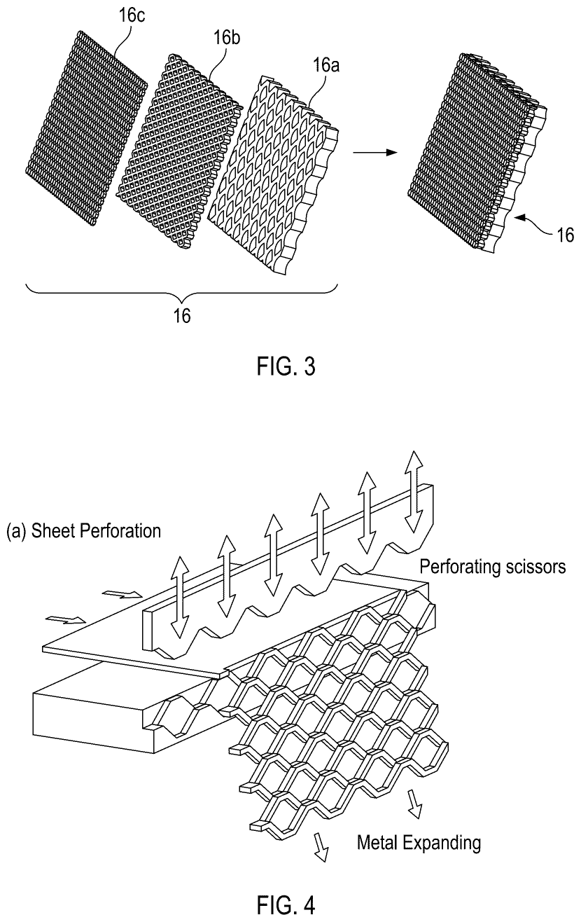

Referring now to FIGS. 2 and 3, the present disclosure provides an anode pack assembly 10 (FIG. 2) comprising a bipolar plate 12, a multilayer anode side flow field 14 and a multilayer anode PTL 16 (FIG. 3). The layers 12, 14, 16 are vacuum diffusion bonded together into a single pack 10 and PVD coated on the respective outer surfaces to form a complete integrated subassembly ready for assembly into the electrolyzer stack (see FIG. 1).

The anode bipolar plate is conventional in the art and may comprise a Titanium plate of an appropriate thickness and design for the intended stack application. Other materials are also contemplated.

The multi-layer anode flow field may comprise a plurality of Titanium metal layers having a larger porosity (up to 1 mm pores), but preferably 100 μm or greater. In some embodiments, the flow field pores may be formed by expanded metal layers, wet-etched lithography, laser drilling or other suitable technology.

In some embodiments, flow field may comprise 1 or more layers of material, but more preferably between 2 to 8 layers of material.

The multi-layer PTL 16 may comprise a plurality of layers of micro-expanded mesh Titanium (Ti) foil. The individual layers may have varying sheet thicknesses and pore sizes as will be described hereinafter. Pore sizes may range inclusively from 3 μm-30 μm and the expanded metal foil layers may have a mesh open area of 10-50%. In some embodiments, there may be three micro-expanded metal layers (16A, 16B, 16C) of decreasing pore size traversing from the flow field side to the catalyst side (further details below).

The present anode pack integrates three technologies.

A) Micro-expanded metal mesh—The implementation of precision manufacturing technologies into expanding metal manufacturing process allow the manufacture of micro-expanded porous mesh with pore sizes of: Optimized sizing may generally be in the range of 10-20 μm diameter pores with a mesh open area of >20%. In some embodiments, pore sizes of 10 μm are preferred with a mesh open area, or porosity, of >30%. (These characteristics represent at least a 10× reduction in pore size relative to current expanding capabilities and a 3× increase in open area. The use of micro-expanded PTLs results in a high-performing component that meets capital cost goals using a scalable, zero waste mechanical fabrication method. Fabrication of PTLs with micro-expanded mesh provides precise control over thickness, porosity, tortuosity, pore connectivity, and surface roughness while resulting in a near zero distribution in pore sizes. Due to the unprecedented control over PTL properties, an optimized micro-expanded PTL in accordance with the present invention is capable of meeting current governmental performance targets and can be further optimized for operation in cells with low catalyst loadings. Objectives of the invention include providing micro-expanded PTLs which meet a cell performance of 1.8 V at 3.0 A/cm2 while meeting a cost of less than $39/kW for an anode pack with a micro-expanded PTL. Micro-expanded PTL designs and methods in accordance with the present invention also permit optimization of PTL layers and electrolyzer configurations with lower catalyst loadings.

B) Diffusion Bonding—Micro-expanded PTL layers and expanded metal flow field layers are diffusion bonded to a bipolar plate, producing an anode pack assembly 16 in a single bonding step (FIG. 2). The implementation of diffusion bonding in anode pack fabrication improves the interfaces between the PTL, flow field, and bipolar plate by the creation of permanent metallurgical bonds between adjoining layers (further explanation below). With the improved bonding, the anode pack 16 has improved durability without the need for precious metal corrosion inhibitors within the interior of the anode pack (i.e. without coating each individual later). The objectives of the invention include scaled manufacturing at an annualized production capacity of 300 MW/year and a cost of less than $39/kW while meeting durability of 2.3 mV/khr at 3.0 A/cm2 in a 3-cell stack.

C) Physical Vapor Deposition (PVD) coating—The diffusion bonded anode pack 16 is coated on respective sides in a single pass through an in-line PVD coating system.

### A) Micro-Expanded Ti Foil PTLs

The porous characteristics of expanded mesh make it ideal for PTL applications. Metal expanding is a metal forming process initially developed in 1884 in which a blade with defined tooth pitch slits a metal sheet subsequently drawn to open the slits into predictable, repeatable well-defined pores (see FIG. 4).

Expanded metal mesh is subsequently flattened through a series of rollers (not shown) such that the final mesh sheet attains flat surfaces with a material thickness of the original sheet. Expanded metal has diverse applications as structural components, energy absorbing materials, filters, and electrodes for battery applications. Properties include high strength and rigidity, mass efficiency, and high porosity. Expanded metal is highly economical due to its production directly from sheet metal with near zero waste material. For this reason, in addition to the predictable, repeatable nature of expanded metal pores, components utilizing metal foam, porous sinters, or woven metal wire often become replaced by expanded-metal-based components when possible. In some existing PEM electrolyzer systems, conventional expanded metals with pore sizes of up to 1 mm (1000 μm) have found application as a three-dimensional flow field in which several layers of expanded metal are stacked between the bipolar plate and PTL.

The main purpose of the PTL, sitting between the catalyst layer on top of the membrane and the flow field, is to provide electrical contact to the catalyst layer, remove heat, and permit mass transport to and from the catalyst layer. The PTL ideally consists of a three-dimensional network of pores within a metallic matrix that provides minimal resistance to fluid transport between the flow field and the catalyst layer and provides intimate electrical contact, critical for advanced low-loading catalyst layers with poor in-plane electrical conductivity, through the metallic layers. Design considerations are dominated by optimizing transport of reacting species to and from the catalyst layer where reaction occurs at the multi-phase boundary between liquid water, gaseous products, the proton-conducting membrane/ionomer, the electron-conducting PTL, and the catalyst. Driven by these considerations, the optimal mean pore size of the PTL in contact with the catalyst layer has been found to be in the range of 10-15 μm with a porosity >20%. Though the ideal PTL shares many characteristics with expanded metal flow fields, prior art expanding methods are not capable of generating pores of this small size. At present, standard expanding technology is limited to expanding blades having a tooth pitch down to 1 mm, a step precision of −100 μm, and a stroke rate of up to 600 strokes per minute.

Mask-patterned wet-etching lithography may allow pore sizes down to 100 μm but as noted above, the optimal mean pore size is still 10× smaller (10 μm).

Fabricating a mesh with the pore requirements of optimized PTLs as described above, requires novel micro-expanding technologies and methods as disclosed herein. Creating 10 μm pores requires a micro-expanding blade with a tooth pitch of at most 18 μm.

After each stroke, the expanding blade moves across and down the sheet <10 μm in each direction with a precision <0.1 μm. Due to the small step size, more that 1500 strokes may be required to produce 1 cm length of mesh.

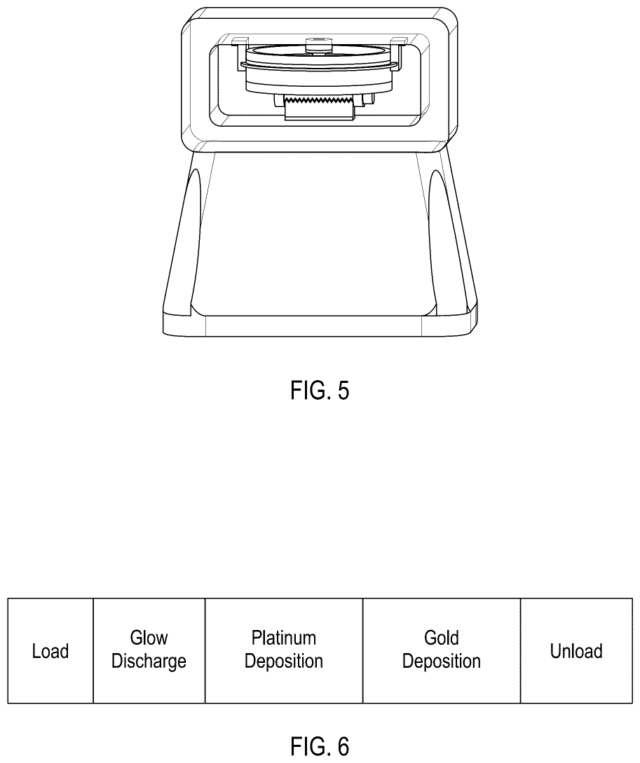

To achieve the high precision requirements of 10 μm mesh, a micro-expanding machine incorporates several precision control technologies and fabrication methods including:
a) femto-laser fabrication of the carbide teeth of the expanding blade;
b) piezoelectric actuation of the expanding blade,
c) precision flexure bearings,
d) active liquid cooling of the piezoelectric actuator housings to maintain temperature control within 1 degree c., and
e) vibration dampening of the base and frame, all contained within a structure designed to withstand the vibratory motion of more than 3000 strokes per minute. A proposed configuration of an expanding machine is illustrated in FIG. 5.

The expanding blade may be fabricated with 500-5000 teeth per inch with 5-50 μm spaces between the teeth.

In an exemplary embodiment, a platinum foil with a thickness of 12.5 μm is passed through the expanding machine to create an expanded metal mesh material. Exemplary pore sizes may range from 3-30 μm and the expanded metal foil layers may have a mesh open area of 10-50%.

Expanded mesh created by the micro-expanding machine may pass through a flattener (not shown) to ensure that the expanded mesh re-attains the thickness of the initial foil without significant bowing in the middle of the mesh. Even with mesh of 12.5 μm thickness, this can be achieved with commercial flattening machines. In addition, the micro-expanding mesh roughness is controlled by the roughness of the flattening rolls, which can be obtained commercially down to an Ra roughness of 25 nm, far below that achievable by sintered PTLs (>1 μm).

Creating a PTL 16 from micro-expanded mesh requires multiple layers of expanded mesh stacked together and diffusion bonded. These layers can be generated from meshes with different pore sizes and orientations, with the general design principle that there should exist a flow path through the PTL for every pore. Because the micro-expanding machine is capable of generating uniform pores of relevant sizes and open areas, micro-expanded mesh provides precision control over the design and performance of the PTL. This control enables seamless adaptation of the PTL layers to the significant and growing body of research on optimal PTL characteristics to quickly optimize a micro-expanded PTL system.

Referring back to FIG. 3, an exemplary embodiment of a PTL 16 comprises a 3-layer PTL design comprising:
1) a 50 μm thick layer with 60 μm pores (16A),
2) a 25 μm thick layer with 30 μm pores (16B), and
3) a 12.5 μm thick layer with 15 μm pores (16C), stacked in the anode pack 10 with the largest pore layer 16A against the flow field 14.

FIG. 3 depicts both the individual layers (16A, 16B, 16C) and the combined PTL stack (16). A 540 μm×540 μm section of a PTL 16 consisting of 3 layers of micro-expanded mesh is illustrated in exploded view (left side) and combined (right side). As noted above, pore sizes of each layer are 15 μm, 30 μm, and 60 μm such that a fluid path exists through the PTL for each 15 μm pore adjacent the catalyst layer.

Preliminary techno-economic modeling indicates that the 3-layer micro-expanded PTL may fabricated at a cost less than current sintered Ti PTLs.

In comparison to current state-of-the-art sintered powder PTLs, a micro-expanded PTL design has many compelling advantages including: 1) controllable porosity—tunable up to 50% open area; 2) fixed, controllable, graded pore sizes—in each layer of the micro-expanded PTL the effective pore size distribution is 0; 3) reduced layer thickness—while sintered PTLs are typically 250 μm thick, a 3-layer micro-expanded PTL would be 90 μm thick, with individually fabricated layer thicknesses down to 13 μm; 4) lower tortuosity—the micro-expanded PTL has nearly direct fluid pathways through plane and the graded porosity provides lateral pathways for bubble consolidation; and 5) lower surface roughness—attainable down to an Ra of 25 nm.

### B) Diffusion Bonding

A primary drawback of expanded metal flow fields in PEM electrolyzer systems is the high contact resistance that develops between adjacent expanded mesh layers during operation. For titanium-based expanded mesh, this high contact resistance is attributed to the growth of a resistive layer of TiO₂. Methods to prevent this increase in interfacial contact resistance are limited and current practice is to coat each individual mesh layer with platinum. Diffusion bonding, in which adjacent mesh layers are metallurgically bonded to each other, eliminates the need for platinum coating of individual mesh layers. Diffusion bonding of titanium is carried out at high pressure (1-10 MPa), high temperature (800-1100° C.), and within high vacuum (<10-5 torr). This requires specialized vacuum furnaces and fixturing capable of applying the requisite pressures in-situ.

Under these conditions, atoms inter-diffuse across the adjacent mating surfaces of the work pieces to form a monolithic joint indistinguishable from the parent material. As the mating surfaces are now part of bulk of the material, there is no longer a surface for TiO₂ to grow eliminating the increase in interfacial contact resistance. Diffusion bonding can therefore bond the individual mesh layers of the flow field together. Similarly, diffusion bonding can also bond the individual PTL layers together, as well as the outermost flow field layers to the PTL and to the bipolar plate. The present invention implements bonding all the layers of the PTL 16, the flow field 14, and the bipolar plate 12 to generate an integrated anode pack assembly 10 in one step, eliminating multiple process steps and minimizing process costs.

### C) Physical Vapor Deposition (PVD)

With a diffusion bonded anode pack assembly 16, precious metal (platinum group metals) coatings are needed only on the outer surface of each side of the pack assembly. Due to the high porosity of the anode pack, the standard deposition method of electroplating leads to excessive deposition of precious metal due to the difficulty of limiting deposition to the surface layer. PVD provides a significantly improved line-of-sight deposition method suited to coating the surfaces of the present anode pack assembly.

PVD encompasses a large family of deposition methods, of which DC magnetron sputtering is one of the simplest and most economical coating methods for depositing thin layers of metal. This technique is used for the metallization of microelectronic circuits, the application of magnetic films for magnetic storage devices, optical storage films for CDs and DVDs, as well as decorative coatings for jewelry. Economic magnetron sputtering has been achieved for high volume manufacturing of optical discs. On these discs a thin (<100 nm) coating of aluminum is applied to create a reflective coating that allows the disc to be read by a laser system. Since the 1980's, this coating has been sputtered onto the discs a single disc at a time using an in-line coating system coated at a rate of less than 2 seconds per disc. One challenge of these systems is the low utilization of the targets (<50%) before the target needs to be replaced. To be cost effective, this material (consisting of platinum group metal targets) will be recycled into new targets to recover the value of the material.

An in-line PVD coating system with a per pack cycle time of less than 5 minutes inclusive of the establishment of vacuum and coating of multiple materials is disclosed in FIG. 6.

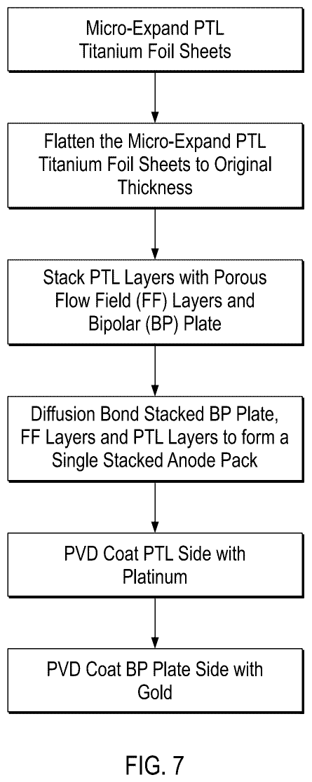

A method for manufacturing a completed anode pack in accordance with the teachings of the present invention is illustrated in flow chart form in FIG. 7.

Accordingly, it can be appreciated that the present invention will provide a novel anode pack assembly which includes a Porous Transport Layer (PTL) formed from multiple layers of micro-expanded metal mesh. The disclosure further provides production-scale equipment to manufacture anode packs at a cost target ($39/kW) suitable for meeting the $2/kg H2 production cost target. In addition, development of a micro-expanded PTL will create the first economically competitive PTL alternative to sintered powder and sintered fiber PTLs.

Specific objectives of the invention can be achieved with the following criteria.

1. An electrolyzer porous transport layer (PTL) comprising at least one micro-expanded Titanium (Ti) foil sheet having a sheet thickness in an inclusive range of 10 μm to 45 μm, pore sizes in the inclusive range of 3 μm to 30 μm, a pore density in an inclusive range of 10% to 50% and a surface roughness (Ra) of 25 nm or greater.

2. An electrolyzer PTL comprising a plurality of overlaid micro-expanded Ti foil sheets.

3. An electrolyzer PTL wherein each sheet of said plurality of overlaid micro-expanded Ti foil sheets has a progressively smaller pore size from an outer side to an inner side.

4. An electrolyzer PTL wherein each sheet of said plurality of overlaid micro-expanded Ti foil sheets has a progressively smaller thickness from an outer side to an inner side and each sheet of said plurality of overlaid micro-expanded Ti foil sheets has a progressively smaller pore size from an outer side to an inner side.

5. An electrolyzer PTL comprising 3 overlaid Ti foil sheets wherein an inner sheet has a pore size of X, a middle sheet has a pore size of about 2X and an outer sheet has a pore size of about 3X, whereby a fluid path exists through the PTL for each pore in the inner sheet.

6. An electrolyzer anode pack assembly comprising: a bipolar plate; a porous flow field, wherein the porous flow field comprises at least one layer of expanded metal mesh having a pore size of 100 μm or greater; and a porous transport layer (PTL) comprising at least one micro-expanded Titanium (Ti) foil sheet having a sheet thickness in an inclusive range of 13 μm to 45 μm, pore sizes in the inclusive range of 3 μm to 30 μm, a pore density in an inclusive range of 10% to 50% and a surface roughness (Ra) of 25 nm or greater.

7. An electrolyzer anode pack assembly comprising a plurality of overlaid micro-expanded Ti foil sheets.

8. An electrolyzer anode pack assembly wherein each sheet of said plurality of overlaid micro-expanded Ti foil sheets has a progressively smaller pore size from an outer side to an inner side.

9. An electrolyzer anode pack assembly wherein each sheet of said plurality of overlaid micro-expanded Ti foil sheets has a progressively smaller thickness from an outer side to an inner side.

10. An electrolyzer anode pack assembly wherein each sheet of said plurality of overlaid micro-expanded Ti foil sheets has a progressively smaller thickness from an outer side to an inner side.

11. An electrolyzer anode pack assembly wherein each sheet of said plurality of overlaid micro-expanded Ti foil sheets has a progressively smaller thickness from an outer side to an inner side and each sheet of said plurality of overlaid micro-expanded Ti foil sheets has a progressively smaller pore size from an outer side to an inner side.

12. An electrolyzer anode pack assembly comprising 3 overlaid Ti foil sheets wherein an inner sheet has a pore size of X, a middle sheet has a pore size of about 2X and an outer sheet has a pore size of about 3X, whereby a fluid path exists through the PTL for each pore in the inner sheet.

13. An electrolyzer anode pack assembly comprising 3 overlaid Ti foil sheets wherein an inner sheet has a thickness of X, a middle sheet has a thickness of about 2X and an outer sheet has a thickness of about 3X.

14. An electrolyzer anode pack assembly wherein the bipolar plate, porous flow field and PTL are diffusion bonded together into an integrated anode pack assembly

15. An electrolyzer anode pack assembly wherein an outwardly facing surface of the bipolar plate is PVD coated with gold and wherein an outwardly facing surface of the PTL is PVD coated with platinum.

Fabrication of the anode packs using diffusion bonding and PVD coating provides novel opportunities for high-volume, high-throughput manufacturing, and integrates the technologies in a single-step diffusion bonding process and single-pass multi-component PVD coating.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described.

What is claimed is:

1. An electrolyzer porous transport layer (PTL) comprising at least one micro-expanded Titanium (Ti) foil sheet having a sheet thickness in an inclusive range of 10 μm to 45 μm, pore sizes in the inclusive range of 3 μm to 30 μm, a pore density in an inclusive range of 10% to 50% and a surface roughness (Ra) of 25 nm or greater.

2. The electrolyzer PTL of claim 1 comprising a plurality of overlaid micro-expanded Ti foil sheets.

3. The electrolyzer PTL of claim 2 wherein each sheet of said plurality of overlaid micro-expanded Ti foil sheets has a progressively smaller pore size from an outer side to an inner side.

4. The electrolyzer PTL of claim 2 wherein each sheet of said plurality of overlaid micro-expanded Ti foil sheets has a progressively smaller thickness from an outer side to an inner side.

5. The electrolyzer PTL of claim 3 wherein each sheet of said plurality of overlaid micro-expanded Ti foil sheets has a progressively smaller thickness from an outer side to an inner side.

6. The electrolyzer PTL of claim 3, comprising 3 overlaid Ti foil sheets wherein an inner sheet has a pore size of X, a middle sheet has a pore size of 2X and an outer sheet has a pore size of 3X, whereby a fluid path exists through the PTL for each pore in the inner sheet.

7. The electrolyzer PTL of claim 5, comprising 3 overlaid Ti foil sheets wherein an inner sheet has a pore size of X, a middle sheet has a pore size of 2X and an outer sheet has a pore size of 3X, whereby a fluid path exists through the PTL for each pore in the inner sheet.

8. The electrolyzer PTL of claim 4, comprising 3 overlaid Ti foil sheets wherein an inner sheet has a thickness of X, a middle sheet has a thickness of 2X and an outer sheet has a thickness of 3X.

9. The electrolyzer PTL of claim 5, comprising 3 overlaid Ti foil sheets wherein an inner sheet has a thickness of X, a middle sheet has a thickness of 2X and an outer sheet has a thickness of 3X.

10. An electrolyzer anode pack assembly comprising:
a bipolar plate;
a porous flow field, wherein the porous flow field comprises at least one layer of expanded metal mesh having a pore size of 100 μm or greater; and
a porous transport layer (PTL) comprising at least one micro-expanded Titanium (Ti) foil sheet having a sheet thickness in an inclusive range of 13 μm to 45 μm, pore sizes in the inclusive range of 3 μm to 30 μm, a pore density in an inclusive range of 10% to 50% and a surface roughness (Ra) of 25 nm or greater.

11. The electrolyzer anode pack assembly of claim 10 comprising a plurality of overlaid micro-expanded Ti foil sheets.

12. The electrolyzer anode pack assembly of claim 11 wherein each sheet of said plurality of overlaid micro-expanded Ti foil sheets has a progressively smaller pore size from an outer side to an inner side.

13. The electrolyzer anode pack assembly of claim 11 wherein each sheet of said plurality of overlaid micro-expanded Ti foil sheets has a progressively smaller thickness from an outer side to an inner side.

14. The electrolyzer anode pack assembly of claim 12 wherein each sheet of said plurality of overlaid micro-expanded Ti foil sheets has a progressively smaller thickness from an outer side to an inner side.

15. The electrolyzer anode pack assembly of claim 12, comprising 3 overlaid Ti foil sheets wherein an inner sheet has a pore size of X, a middle sheet has a pore size of 2X and an outer sheet has a pore size of 3X, whereby a fluid path exists through the PTL for each pore in the inner sheet.

16. The electrolyzer anode pack assembly of claim 14, comprising 3 overlaid Ti foil sheets wherein an inner sheet has a pore size of X, a middle sheet has a pore size of 2X and an outer sheet has a pore size of 3X, whereby a fluid path exists through the PTL for each pore in the inner sheet.

17. The electrolyzer anode pack assembly of claim 13, comprising 3 overlaid Ti foil sheets wherein an inner sheet has a thickness of X, a middle sheet has a thickness of 2X and an outer sheet has a thickness of 3X.

18. The electrolyzer anode pack assembly of claim 14, comprising 5 overlaid Ti foil sheets wherein an inner sheet has a thickness of X, a middle sheet has a thickness of 2X and an outer sheet has a thickness of 3X.

19. The electrolyzer anode pack assembly of claim 10 wherein the bipolar plate, porous flow field and PTL are diffusion bonded together into an integrated anode pack assembly.

20. The electrolyzer anode pack assembly of claim 10 wherein an outwardly facing surface of the bipolar plate is PVD coated with gold and wherein an outwardly facing surface of the PTL is PVD coated with platinum.
